(19) United States
(12) Patent Application Publication
(10) Pub. No.: US 2009/0294188 A1
(43) Pub. Date: Dec. 3, 2009

(54) Motorized axle for use with environmentally friendly vehicles

(76) Inventor: Monty Cole, Santa Barbara, CA (US)

Correspondence Address: LAW OFFICES OF ANDREW SCHROEDER, P.O. Box 6731, Santa Maria, CA, 93454, US

(21) Appl. No.: 12/156,728

(22) Filed: Jun. 2, 2008

(51) Int. Cl. B60K 1/00

(52) U.S. Cl. 180/65.1

(57) ABSTRACT

An improved motorized axle system for use in vehicles comprising:
a first motorized axle and a second motorized axle;
the first motorized axle is larger than the second motorized axle;
each motorized axle comprises: a stator block, a stator, a rotor, at least two bearings, and an axle;
the stator block comprising an upper member and a lower member for use in providing a housing for the stator and rotor;
the stator comprising at least one armature coil for forming a rotating magnetic field;
the rotor comprising a set of permanent magnets;
the axle comprising an axle drive line having a first end and a second end, the axle drive line being elongate and adapted to define the width of a vehicle;
the bearings are disposed around the rotor shaft circumferentially.

### CROSS-REFERENCE TO RELATED APPLICATIONS

A MOTORIZED AXLE FOR USE WITH ENVIRONMENTALLY FRIENDLY VEHICLES: Ser. No. 11/486,947

### FIELD OF THE INVENTION

The present invention relates to motors, and more specifically relates with a high torque, low RPM, brushless DC motor generator for use with vehicles or other power needs.

### BACKGROUND OF THE INVENTION

For years there has been a strong desire amongst governments, consumers, and environmental groups to reduce our dependence upon petroleum products. Byproducts from petroleum based products have created a wide array of problems for everyone.

One problem often associated with petroleum byproducts is the attendant air pollution it creates within our atmosphere. Chemicals such as Carbon Dioxide, Carbon Monoxide and other Phosphates pollute our air everyday as a direct result of burning petroleum products. Many scientists believe that the addition of these byproducts into our atmosphere has led to a greenhouse effect within our planet. According to the greenhouse gas theory, as carbon byproducts accretes into our atmosphere in massive quantities it forms a layer high in Earth's atmosphere. This layer of carbon acts as a lid which prevents heat from Earth to escape from Earth's atmosphere. As a result, this trapped energy or heat gradually works to increase the temperature of our planet.

Scientists have warned about the dire consequences of rising planetary temperatures for decades. These rising temperatures can result in changing weather patterns across the globe. These changing weather patterns can result in more hurricanes, tornadoes, or in some cases droughts in some regions. Rising temperatures can also result in the melting of the polar ice caps which may increase the sea level of our oceans. Scientists believe that even a small increase in the sea levels can leads to massive flooding of low-lying coastal regions where a large portion of people currently populate.

Another problem which has developed are increasing tensions between OPEC countries with the rest of the world. As these tensions over oil supplies increase it is expected that terrorism may increase.

Moreover, expanding demand for gasoline in developing countries such as India and China will inexorably stoke ravenous demands for oil. As this demand increases gas will soon become too expensive for many Americans to feasibly commute to work from far-away distances.

One way in which these problems may be eliminated or at least mitigated is to produce fuel efficient cars which burn far less gasoline or no gasoline at all. Currently, an average gas combustion engine realizes only about 5% of its energy into the transmittal of energy to propulsion. Most of the 95% energy loss is due to transmissions, gears, heat, and engine friction.

In order to create energy efficient vehicles, combustible engines should be replaced due to their intrinsic inefficiencies. Combustion engines by design generate high friction and heat within the engine blocks in order to transmit energy to the crankshaft. Coupled with this engine block other parts further encumber the process such as the transmission and gear assemblies. This assemblage of hundreds of parts collectively contribute to great inefficiencies within this engine.

Generally, thermodynamically efficient engines are supposed to contain and conserve as much heat and energy as possible without much excitation loss. Moreover, thermodynamically efficient engines should also transmit as much energy from the energy source to the element to which the energy is supposed to act upon. Unfortunately, combustible engines are not often described with these characteristics.

Perhaps the main reason why combustion engines are the widely accepted standard for automotive propulsion is that it is comparatively inexpensive. However, the combustible engine is an old contraption which is becoming more cost prohibitive. However, these electric automobiles do not come without their problems and shortcomings. First, many electric vehicles are simply too expensive for most people to afford. Although these prices may drop in time and with increased economies of scale electric vehicles may remain out of reach of the budgets of most people because gas-combustion engines are easier and cheaper to produce and manufacture.

Another problem which inheres with most electric vehicles is their lack of power and speed. Most electric vehicles are not designed for the necessary power it takes to proficiently climb steep hills which are prevalent in many regions across the world. In addition, this lack of power does not make electric vehicles expedient for towing, cargo, freight, or even hauling furniture to a new home.

Another persistent problem with most electric vehicles is their limited range and lack of fuel stations. Whereas most gas-powered vehicles can drive anywhere from 200-300 miles per tank of gas, electric vehicles are limited to a far shorter range. In addition, to date there are not many stations across the freeways where one can re-fuel for longer trips. Furthermore, many of these electric vehicles can take several hours to re-charge whereas most vehicles can re-fill their gas tanks in less than five minutes.

Another problem which inheres with most electric vehicles is the fact that they require transmissions and other apparatus which are very inefficient at transmitting power and energy into propulsion. Furthermore, current electric motor design in electric vehicles use outdated technology (in some cases over 100 years old) which is typically, high RPM and low torque. In addition, these motors are very difficult to repair and often require complete replacement thereof. This confluence of inefficiencies contribute to many of our environmental problems as well as our current oil shortage supplies. The inefficiencies of electric vehicles leave them out of reach from implementing solar technology as a feasible energy source for propulsion. If electric vehicles were more efficient, harvesting solar energy would be a more feasible option.

Therefore, what is clearly needed in the art is a highly efficient, low RPM and robust motor which provides high torque, and which is adaptable for use in electric vehicles. This motor should be electronically controllable. In addition, such a motor should be efficient enough to be able to be powered by solar energy for most of its energy needs in combination with a modern battery system.

### SUMMARY OF THE INVENTION

It is an object of the present invention to provide an improved motorized axle system which incorporates a larger axle for lower speeds and increased power needs and also a smaller axle for higher speeds and for more efficient propulsion.

It is an object of the present invention to provide a highly efficient propulsion means with vehicles. This device will enable a vehicle to attain high efficiency without compromising power, speed, or convenience.

It is a further object of the present invention to provide a motorized axle for the purpose of providing an adaptable propulsion means with electric vehicles, hybrid vehicles, solar vehicles or garden-variety gas combustion or diesel engines. Such a device would be able to seamlessly integrate with these vehicles and provide the sole means of propulsion in the vehicle or may augment the propulsion means in a vehicle.

It is a further object of the present invention to provide a motorized axle for use in vehicles for the purpose of providing an environmentally friendly means of propulsion and transport. This device may in some preferred embodiments be completely emissions free.

### BRIEF DESCRIPTION OF THE DRAWING FIGURES

FIG. 1a is a cross-sectional view of a preferred embodiment of the present invention.

FIG. 1b is a cross-sectional view of a preferred embodiment of the present invention.

FIG. 2 is a plan view of a preferred embodiment of the present invention.

FIG. 3A is an perspective view of a preferred embodiment of the present invention.

FIG. 3B is an perspective view of a preferred embodiment of the present invention.

FIG. 4 is a perspective view of a preferred embodiment of the present invention

FIG. 5 is an perspective view of a preferred embodiment of the present invention.

FIG. 6 is an perspective view of a preferred embodiment of the present invention.

FIG. 7 is an perspective view of a preferred embodiment of the present invention.

FIG. 8 is an perspective view of a preferred embodiment of the present invention.

### DESCRIPTION OF PREFERRED EMBODIMENTS

According to a preferred embodiment of the present invention, a unique motorized axle is used for the propulsion of vehicles. The present invention is described in enabling detail below.

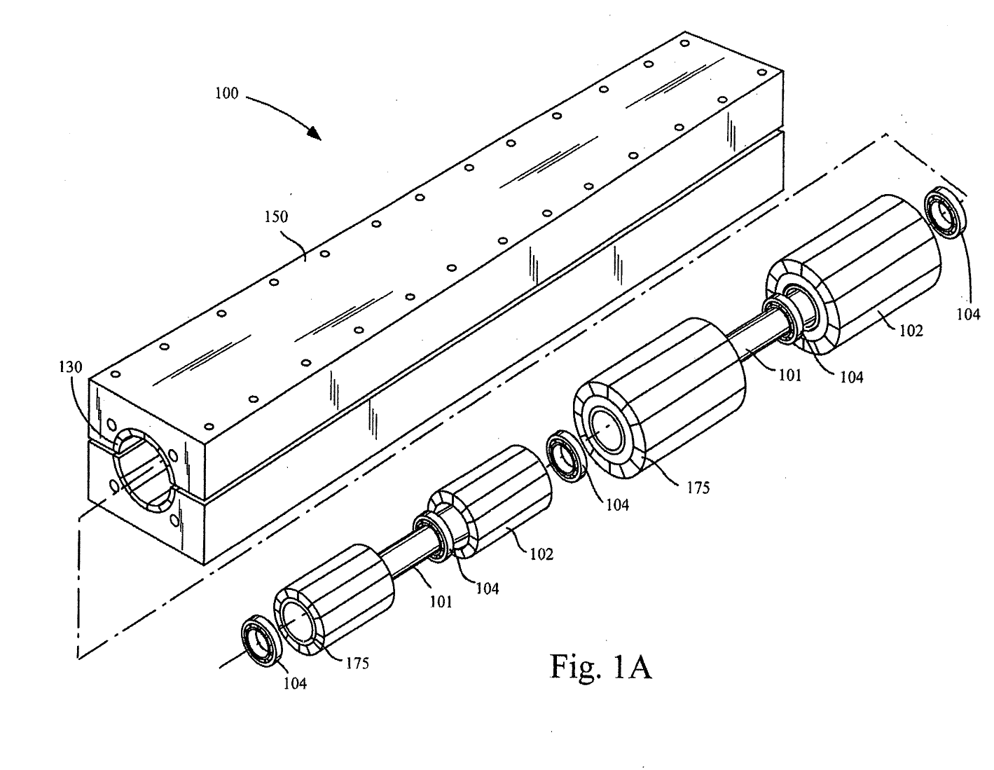

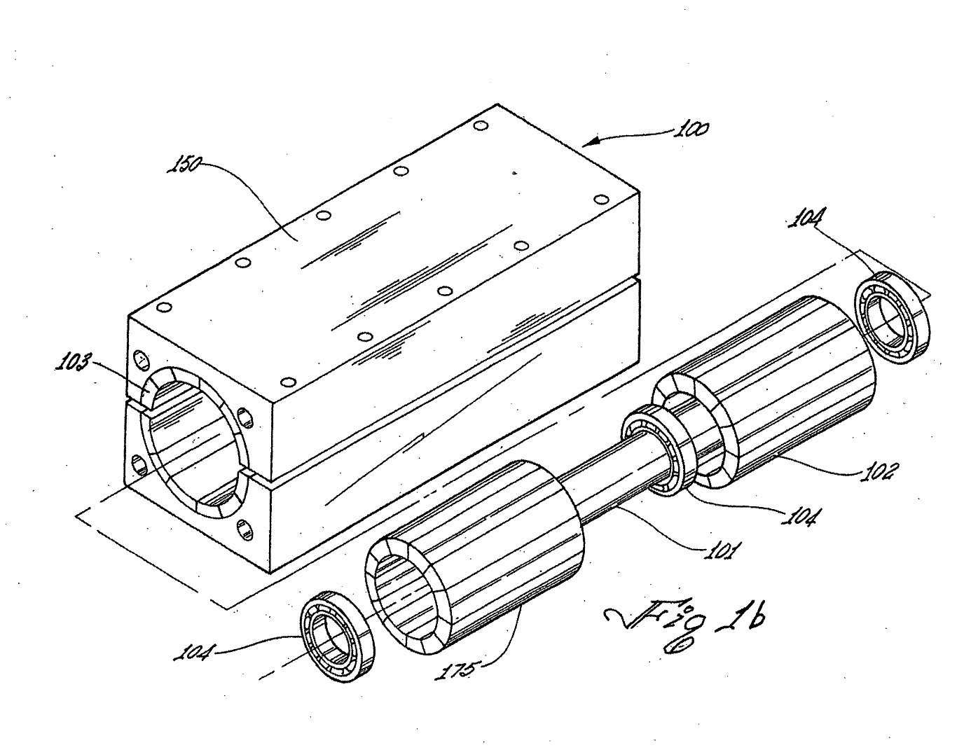

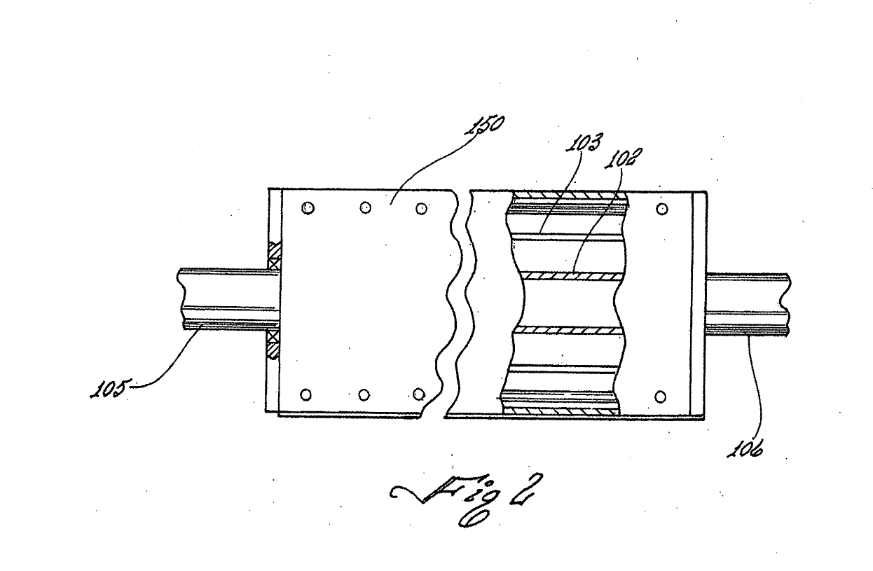

FIG. 1a illustrates one preferred embodiment of an improved motorized axle system 100. The motorized axle system 100 comprises a larger axle and a smaller axle. The larger axle is for use with lower speeds and for performance requiring more power. The smaller axle is for use with higher speeds and for more efficient propulsion. Each motorized axle is comprised of: an axle 101, a rotor 102, a stator 103, bearings, 104, and a stator block 150. FIG. 1b illustrates a preferred embodiment where both motorized axles are sized similarly.

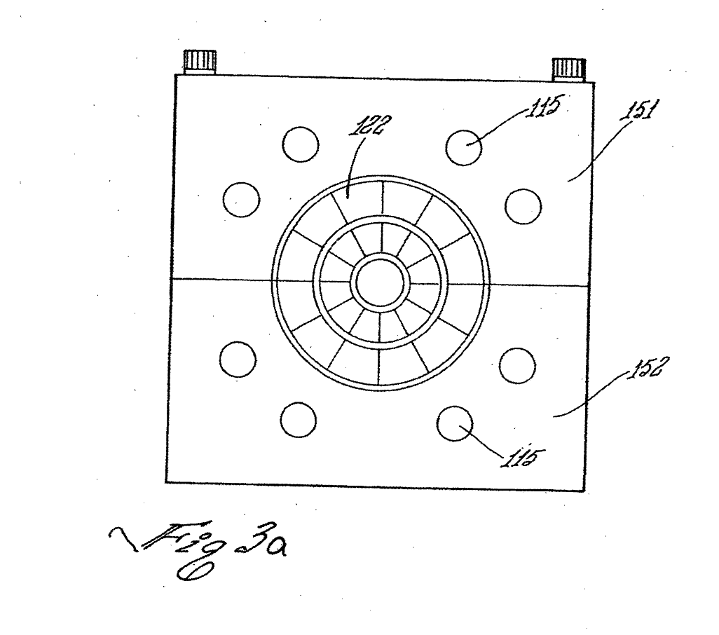

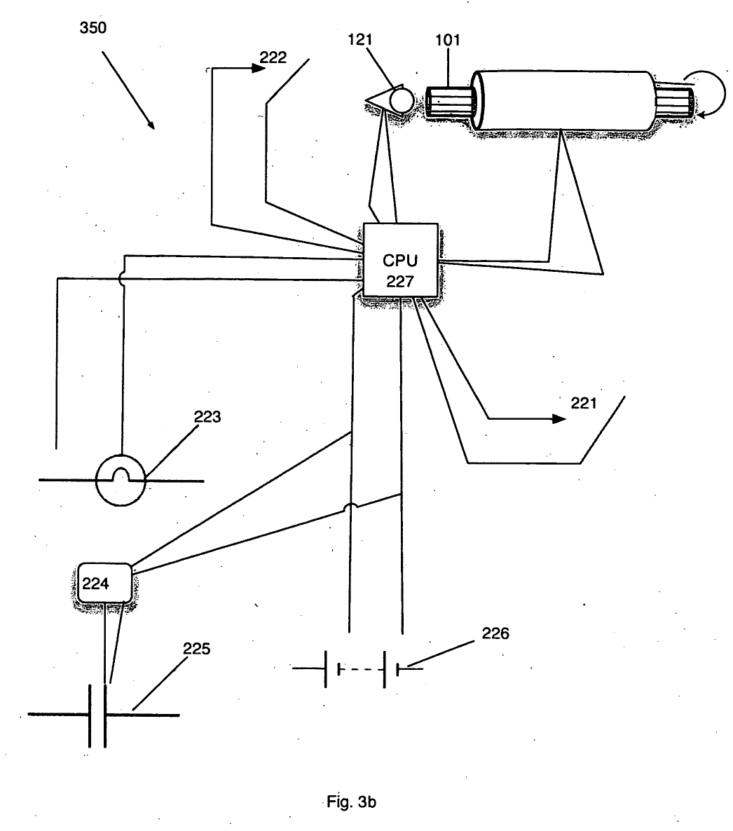

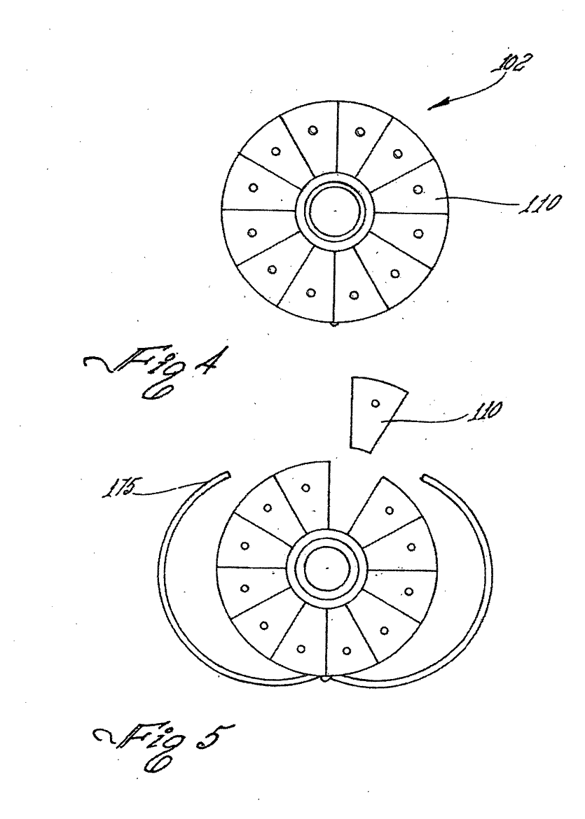

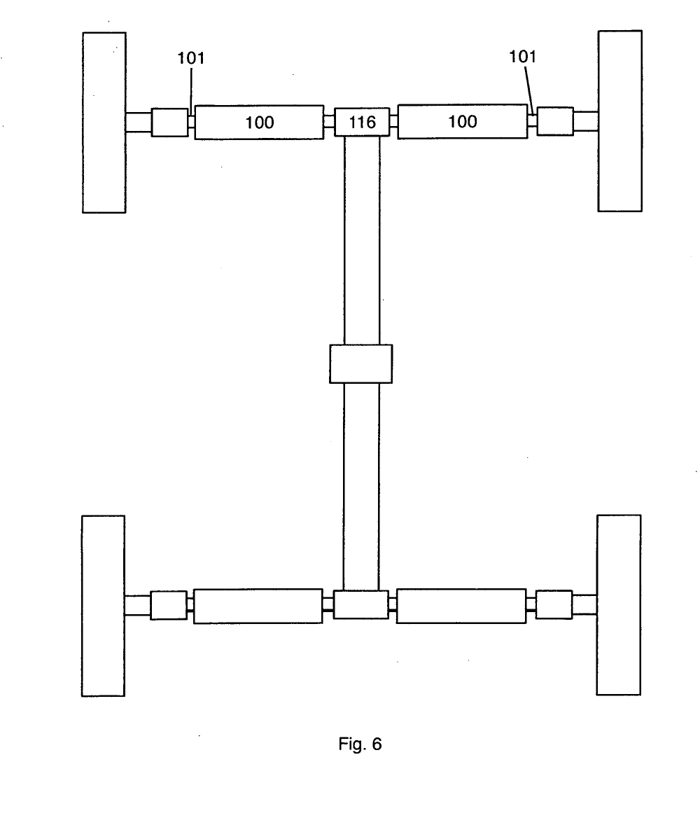

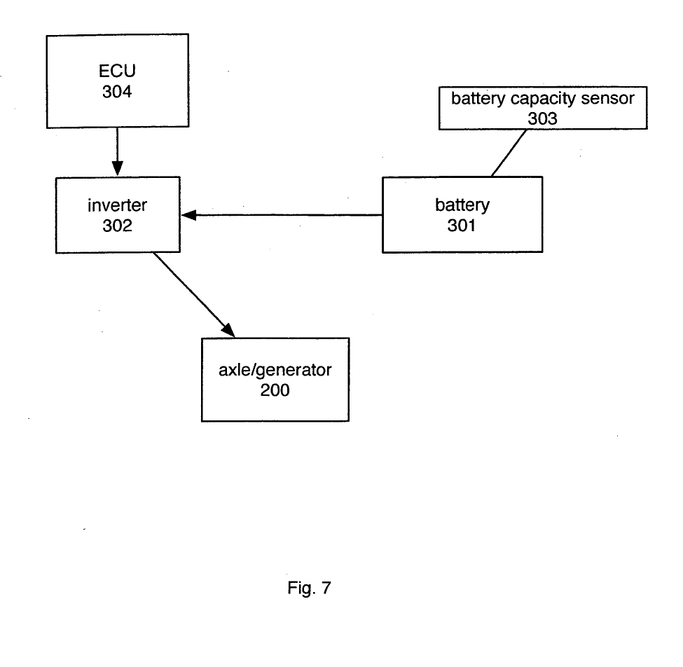

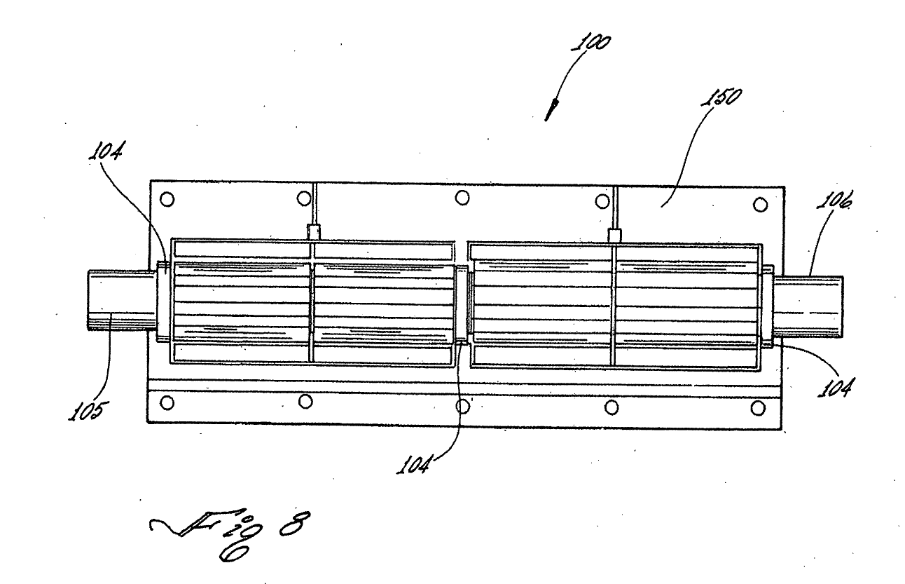

The axle comprises a drive-line with a first end 104, a second end 105. The axle is long enough to approximate the typical width of a vehicle. In some preferred embodiments, there may be two axles on opposite sides of the differential 106 as shown in FIG. 3.

The Motorized axle come in two main embodiments: with Hall sensors 120 or optical sensors 121. In preferred embodiments which incorporate Hall sensors, the Hall sensors are disposed upon or within the rotors. In other preferred embodiments the Motorized axle uses optical sensors. The axle incorporates grooves with indicia or other markings used for the purpose of enabling optical sensors to discern the position and speed of the rotors.

The rotor comprises a set of permanent magnet 110, bearings 104, and a rotor core 111 for forming a magnetic field. In some preferred embodiments the rotor may be composed of titanium or other alloys or composite materials in order to provide the durability it will need for frequent vehicle use. The bearings are disposed around the rotor shaft circumferentially. In some preferred embodiments, there are three sets of bearings distributed along the axis of the rotor. And in some preferred embodiments, the rotor is hollow in order to allow for air cooling. The rotor may slip over the axle in order to facilitate ease of repair or replacement.

In some preferred embodiments the rotor magnets are detachably disposed and easily removed from the rotor by means of a rotor cylinder which houses the rotor and is affixed with the axle. However, some preferred embodiments may achieve the same functions with other means or devices. The possibilities are endless.

The stator block provides the housing for the present invention. In some preferred embodiments, the stator is divided into upper member 150 and lower member 151. Upper and Lower members are conjoined together by disposing bolts into at least two fastening channels. Bolts are anchored into lower member by means of a nut or other fastening apparatus. In addition, upper member and lower member further incorporate detents or similar methods for the purpose of stabilizing the placement of upper member on top of lower member. In some preferred embodiments the stator block may be comprised of aluminum alloy similar to alloys found in aircraft.

In some preferred embodiments the stator block further includes longitudinal channels 115 for the purpose of passing a cooling liquid or a cooling gas through the stator block. These channels may also be incorporated into the rotor in some preferred embodiments.

Cooling liquids or gases are actuated by use of a coolant pump 175. Cooling pump 185 is affixed to the block and is directly powered by a gear to the driveline. It should be noted here that other preferred embodiments may implement other cooling devices. For instance, the present invention may also incorporate a radiator which may integrate a pump to actuate these processes. For these reasons, the cooling means should not be construed to be limiting to the present invention.

It should be noted here that in some preferred embodiments the motorized axle may comprise at least two motorized axles along with accompanying components of stators and rotors. One Motorized axle may be disposed on either side of the differential 116. In this particular design the motorized axle may provide more power. Moreover, with a differential the vehicle may be able to turn with better control and less tire slippage.

It is also noted here that in some preferred embodiments that air may be pumped into the stator block around the rotor areas in order to facilitate heat removal from the inside of the motor. This air would subsequently escape the motor via holes through the rotor and axle thereby further cooling the rotor core area.

In addition, in some preferred embodiments, the motorized axle may function as a generator and may recover residual energy upon deceleration of the vehicle. The motorized axle/generator 200 has functions both as of an electric motor and a generator. More specifically, when the motorized axle/generator 200 acts as an electric motor, it generates an output torque in accordance with an exciting current variably controlled by an exciting current control signal. On the other hand, when the motorized axle/generator 200 acts as a generator, it generates electricity in regenerative braking during deceleration of the hybrid vehicle.

The motorized axle/generator 200 is electrically connected to battery 201 supplying current through inverter. The battery 201 is equipped with a battery capacity sensor 203 detecting an integrating current value which is a parameter representing the state of charge (SOC) of battery 203. The inverter 202 is operated by an electronic control unit (ECU) 205. The battery 201 supplies the motorized axle/generator 200 with electric power through this inverter 202, so that the hybrid vehicle is driven by the motorized axle/generator 200. Inverter 202 is interposed between motorized axle/generator 200 and battery 201 so as to be electrically connectable with each of them, is controlled by ECU 205 so as to establish or release the electrical connection between motorized axle/generator 200 and battery 201, and also to adjust an electric value in the power supply from one element to the other element.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. An improved motorized axle system for use in vehicles comprising: a first motorized axle and a second motorized axle; the first motorized axle for use with lower speeds and the second motorized axle for use with higher speeds; each motorized axle is comprised of a stator block, a stator, a rotor, at least two bearings, and an axle;
the stator block comprising an upper member and a lower member for use in providing a housing for the stator and rotor;
the stator comprising at least one armature coil for forming a rotating magnetic field;
the rotor comprising a set of permanent magnets;
the axle comprising an axle drive line having a first end and a second end, the axle drive line being elongate and adapted to define the width of a vehicle;
the bearings are disposed around the rotor shaft circumferentially.

2. The motorized axle of claim 1 wherein the motorized axle further comprises longitudinal channels for the purpose of passing a cooling liquid or a cooling gas through the motorized axle.

3. The motorized axle of claim 2 wherein the motorized axle further comprises longitudinal channels for the purpose of passing a cooling liquid.

4. The motorized axle of claim 2 wherein the motorized axle further comprises longitudinal channels for the purpose of passing a cooling gas.

5. The motorized axle of claim 2 further comprising a cooling pump.

6. The motorized axle of claim 5 further comprising a liquid cooled stator block, the liquid cooled block is passed through the longitudinal channels for the purpose of cooling the stator block.

7. The motorized axle of claim 5 wherein the rotor is composed of titanium.

8. The motorized axle of claim 5 wherein the rotor is composed of a composite alloy.

9. The motorized axle of claim 1 wherein the motorized axle comprises at least two motorized axles and a differential; the two motorized axles are disposed on opposite sides of the differential.

10. The motorized axle of claim 1 wherein the rotor is hollow for the purpose of allowing air cooling.

11. The motorized axle of claim 9 wherein each motorized axle further comprises at least 3 bearings disposed in between the rotor and the stator to allow the rotor to freely spin within the stator block.

12. The motorized axle of claim 11 wherein the axle further comprises grooves disposed circumferentially, the grooves incorporating indicia for the purpose of discerning the location and speed of the rotor.

13. The motorized axle of claim 11 further comprising optical sensors for the purpose of monitoring the rotor.

14. The motorized axle of claim 9 wherein the Motorized axle is adapted for use with solar technology to charge a battery and a capacitor storage apparatus.

15. The motorized axle of claim 9 wherein the coils are detachably disposed inside the stator block and are easily removed and replaced.

16. The motorized axle of claim 9 wherein the rotor magnets are detachably disposed and easily removed from the rotor by means of a rotor cylinder which houses the rotor and is affixed with the axle.

17. The motorized axle of claim 9 further comprising a power system; the power system comprising a CPU, a battery, an optical scanner; the CPU is in communication with the battery.

18. The motorized axle of claim 17 wherein the motorized axle, having both motor and generator functions to form one driving source for driving wheels of a vehicle and serve as a generating source for generating electric power; the motorized axle generates electric power to charge said battery by utilizing a regenerative braking in a deceleration of said vehicle.

19. The motorized axle of claim 18 further comprising an inverter, the inverter charges said battery by utilizing residual electric power when said electric motor generates excessive electric power.

20. A motorized axle and generator having both motor and generator functions to form one driving source for driving wheels of a vehicle and serve as a generating source for generating electric power; the motorized axle and generator generates electric power to charge said battery by utilizing a regenerative braking in a deceleration of said hybrid vehicle comprising:
a power system, an ECU, an inverter, and a motorized axle;
the motorized axle comprising: a stator block, a stator, a rotor, at least two bearings, and an axle;
the stator block comprising an upper member and a lower member for use in providing a housing for the stator and rotor;
the stator comprising at least one set of armature coils for forming a rotating magnetic field;
the rotor comprising a set of permanent magnets;
the axle comprising an axle drive line having a first end and a second end, the axle drive line being elongate and adapted to define the width of a vehicle;
the bearings are disposed around the rotor shaft circumferentially.
